(19) United States
(12) Patent Application Publication
(10) Pub. No.: US 2004/0252221 A1
(43) Pub. Date: Dec. 16, 2004

(54) Video camera using optical disc

(76) Inventors: Yoshiro Konishi, Mito (JP); Toshimasa Kamisada, Hiratsuka (JP); Yasuo Kitada, Odawara (JP); Ryuichiro Mizuno, Hitachinaka (JP); Chieko Fukui, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/845,078

(22) Filed: May 14, 2004

(30) Foreign Application Priority Data
May 15, 2003 (JP) 2003-136689

(51) Int. Cl. H04N 5/225

(52) U.S. Cl. 348/335

(57) ABSTRACT

A thin video camera using an optical disc, comprises an image pick-up optical system for taking up image data to be picked up, and a view finder for displaying the image data, and an optical disc unit for recording the image data on an optical disc, wherein the optical disc unit is arranged in a plane which faces the optical disc and which is laid in parallel with the optical disc, without being overlapped with the image pick-up optical system.

### INCORPORATION BY REFERENCE

The present application claims priority from Japanese application JP2003-136689 filed on May 15, 2003, the content of which is hereby incorporated by reference into this application.

### BACKGROUND OF THE INVENTION

The present invention relates to a video camera, and in particular to a video camera using an optical disc as a recording medium.

In stead of a magnetic tape which has been conventionally used, a vide camera using an optical disc as a recording medium has been commercially available, as disclosed in JP-A-2001-111877. Such a vide camera uses a DVD-RAM having a diameter of 80 mm as the optical disc. In this video camera, a camera lens and a view finder are arranged in a direction perpendicular to the surface of an optical disc, being overlapped with an optical disc and an optical disc unit.

Referring to FIGS. 5 and 6 which are a side view and a front view, respectively, illustrating a conventional vide camera in an image pick-up mode, using an optical disc, explanation will be made of a positional relationship among the optical disc unit, the camera lens and the view finder in a conventional video camera using an optical disc. In these figures, X-, Y- and Z-axial directions correspond to the longitudinal direction, the widthwise direction and the heightwise direction of the vide camera, respectively.

In FIGS. 5 and 6, there are shown a camera housing 1 incorporating components of the video camera using an optical disc, a camera lens 2 for taking up image data to be picked up, a view finder 3 and a liquid crystal display unit 4 on which the image data is displayed so that the user can confirm an image to be picked up, an optical disc unit 4 for recording the image data taken up by means of the camera lens on an optical disc 5, a camera circuit board 6 mounted thereon with a circuit for controlling the camera lens 2, a chassis 8 holding components of the optical disc unit 4, a spindle motor 9 for rotating the optical disc 5, and an optical head 10B for irradiating a light beam onto the optical disc 5 in order to record the image data on the optical disc 5. The optical head 10B is guided and moved along guide bars 11 by a power which is transmitted to the optical head 10B from a seek motor 12 through the intermediary of a lead screw 14 and a rack 15. The circuit board 13 is mounted thereon with a circuit for controlling the optical disc unit 4, and is connected to the optical head 10B by means of a flexible cable 16.

The optical disc unit 4 is composed of the chassis 8, the spindle motor 9, the optical head 10B, the guide bars 11, the seek motor 12, the circuit board 13, the lead screw 14, the rack 15 and the flexible cable 16. The optical disc 5 is removably loaded on the optical disc unit 4.

In the camera housing 1, the camera lens 2 and the view finder 3 are arranged, being aligned with each other in the X-axial direction. Both camera lens 2 and view finder 3 are juxtaposed with the optical disc unit 4 in the Y-axial direction. In general, the cameral lens 2 and the view finder 3 are arranged in the X-axial direction, coaxial with each other, in the upper section of the camera housing 1 (as viewed in the Z-axial direction) in view of easy handling the video camera using an optical disc. Accordingly, the camera circuit board 6 and the liquid crystal display unit 7 are laid below the camera lens 2 and the view finder 3. A zoom lens is used as the camera lens 2, and cannot be small-sized greatly, in view of such a fact that a predetermined degree of exposure should be ensured. Thus, the camera lens occupies a space having a diameter of about 40 mm, and a length greater than the diameter. The view finder 3 also has the same size as that of the camera lens 2.

The optical disc unit 3 records picked-up data on the optical disc 5. Specifically, a light beam is irradiated onto the optical disc 5 which is mounted on the spindle motor 9 for rotation by the optical head 10B that is connected to the circuit board 13 through the intermediary of the flexible cable 16 so as to record and reproduce the image data thereon and therefrom.

The optical head 10B is mounted on the chassis 8 by the two guide bars 11 spaced from each other by a distance L2 (about 60 mm). Since the rack 15 is meshed with the lead screw 14 of the seek motor 12, the optical head 10B can be moved in the radial direction of the optical disc 11 when the seek motor 12 is rotated.

It is noted that there has been known a video camera using an optical disc, in which the seek motor 12 and the lead screw 14 are laid above the optical head 10B although, in the above-mentioned vide camera using a optical disc, they are laid therebelow (for example, refer to a JP-A-2000-32309).

Referring to FIGS. 7 and 8 which are a plan view and a sectional view, respectively, illustrating the optical head 10B, explanation will be made of the configuration of the optical head 10B used in the above-mentioned prior art (Refer to, for example, JP-A-09-180240).

A laser beam 19 emitted from a laser diode 18 attached to a casing 17, passes through a polarized. beam splitter 30 and is then incident upon a collimating lens 21 so as to be turned into a parallel ray beam which is then reflected upon a rise-up mirror 22, then passes through a polarization diffraction grating 23, and is converged by an objective lens 24 so as to be focused on the optical disc 5. A reflected beam from the optical disc 5 passes through the above-mentioned optical path in a reverse order, and is then reflected by the polarized beam splitter 20 onto a photo detector 30. Data from the optical disc 5 is reproduced by an output from the photo detector 30, and a positional deviation signal between the focused point of the laser beam 19 and a recording surface of the optical disc 5 are detected, and a positional deviation signal between the focused point and a recording track on the optical disc 5.

The polarization diffraction grating 23 and the objective lens 24 is attached to a laser holder 25 which is suspended on four bar suspensions 26, that is, the four bar suspensions 26 are secured at one end thereof (first end) to the lens holder 25, and at the other end thereof (second end) to a holder 27 fixed to the casing 17. The lens holder 25 is attached thereon with a coil (which is not shown) with which a yoke 28 and a magnet 29 are combined so as to constitute a voice coil motor. These components constitute the so-called two-dimensional actuator, and when a current is applied to the coil, the lens holder 25 resiliently held by the bar suspensions 16, and the objective lens 24 and the polarization diffraction grating 23 which are integrally incorporated with the lens holder 25 can be displaced in a two-dimensional plane defined by a direction (Y-axial direction) perpendicular to the surface of the optical disc 5 and the radial direction (X-axial direction) of the optical disc 5. Explanation will be made of the technology of the two dimensional actuator used for the conventional optical head.

For example, as disclosed in JP-A-2001-216665, the lens holder 25 is displaced in the above-mentioned two-dimensional space in response to the above-mentioned two positional deviation signals so as to position the focus point of the laser beam 19 onto a recording track on the recording surface of the optical disc 5.

In the above-mentioned video camera using an optical disc, the camera lens 2 is located at a position which is spaced in the Y axial direction from the optical disc 5 by a distance of about 15 mm with the optical head 10B, the guide bars 11 and the seek motor 12 being interposed therebetween, and also, the view finder 3 is located at a position spaced from the optical disc 5 by a distance of about 15 mm in the Y-axial direction with the seek motor 12 and the circuit board 13 being interposed therebetween. As a result, the thickness W2 of the video camera using an optical disc is about 50 mm.

With the above-mentioned configuration, if the height (the dimension in the Z-axial direction) of the camera housing 1 is set to about 90 mm which is near to the diameter (80 mm) of the optical disc 5, the video camera using an optical disc can have a shape which is easily handled by the human hands.

In general, it is desired to miniaturize and thin a video camera in view of easy handling and portability. However, in the conventional video camera using an optical disc, since the camera lens and the view finder are overlapped with the optical disc unit, the thickness W2 (dimension in the Y-axial direction) of the vide camera becomes larger due to this overlapping. In order to thin the video camera (reduction of the dimension in the Y-axial direction), it would be preferable to thin the seek motor itself and the optical head itself with the overlapping portion. However, it is difficult to greatly thin these parts.

### SUMMARY OF THE INVENTION

The present invention is devised in view of the problems inherent to the above-mentioned conventional technologies, and accordingly, an object of the present invention is to provide a vide camera using an optical disc, which has a reduced width.

According to the present invention, there is provided a vide camera using an optical disc, comprising a pick-up optical system including a camera lens for taking up image data to be picked up and a view finder for displaying the image data, and an optical disc unit for recording the image data onto an optical disc, wherein the optical disc unit is located in a plane facing the optical disc in parallel with the latter, without overlapping with a part of the pick-up optical system.

According to one specific form of the present invention, the above-mentioned optical disc unit is located without overlapping with the camera lens of the pick-up optical system.

According to another specific form of the present invention, the above-mentioned optical disc unit is located without overlapping with the view finder of the pick-up optical system.

According to further another specific form of the present invention, the optical disc unit is located without overlapping with both camera lens and view finder.

In addition to the above-mentioned features and technical effects and advantages, other features and technical effects and advantages of the present invention will become apparent in the following description of preferred embodiments which will be explained with reference to the accompanying drawings in which:

Other objects, features and advantages of the invention will become apparent from the following description of the embodiments of the invention taken in conjunction with the accompanying drawings.

### BRIEF SUMMARY OF SEVERAL VIEWS OF THE DRAWING

FIG. 1 is a side view illustrating an internal configuration of a vide camera using an optical disc in an embodiment of the present invention;

FIG. 2 is a front view illustrating the internal configuration of the vide camera shown in FIG. 1;

FIG. 3 is a plan view illustrating an optical head in the vide camera shown in FIG. 1:

FIG. 4 is a sectional view illustrating the optical head shown in FIG. 3;

FIG. 5 is a side view illustrating an internal configuration of a conventional vide camera using an optical disc;

FIG. 6 is a front view illustrating the internal configuration of the conventional vide camera shown in FIG. 5;

FIG. 7 is a plan view illustrating a conventional optical head; and

FIG. 8 is a sectional view illustrating the optical head shown in FIG. 7.

### DETAILED DESCRIPTION OF THE INVENTION

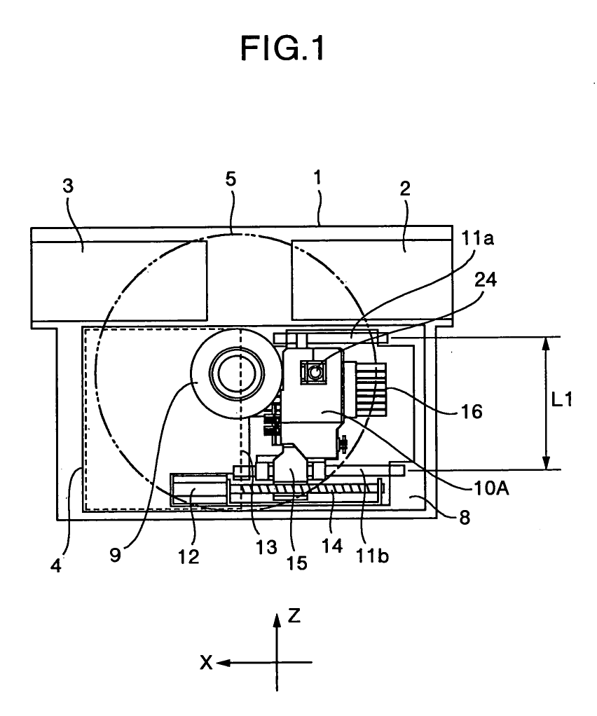

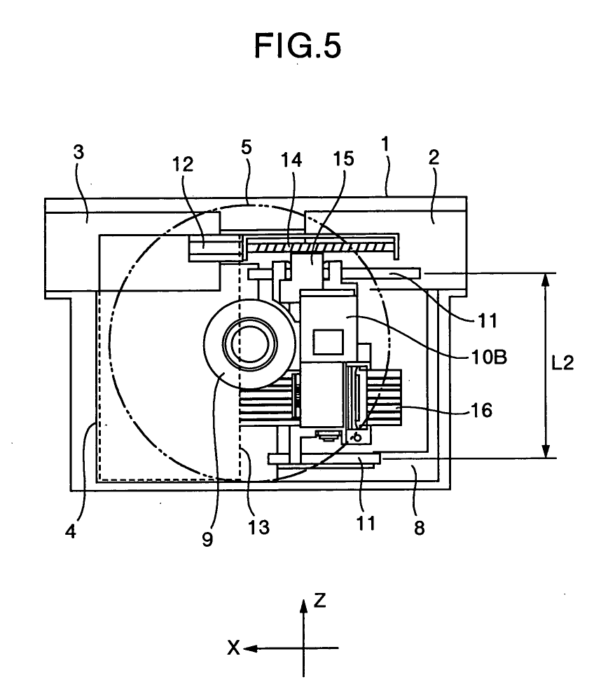

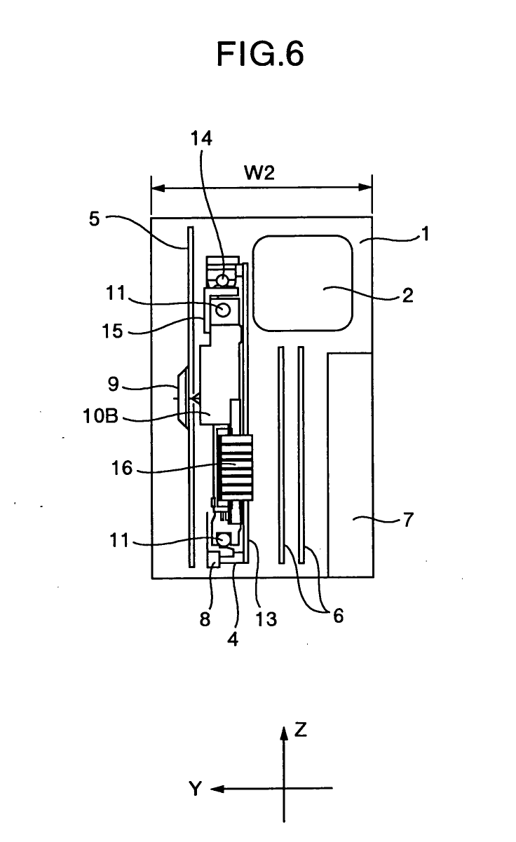

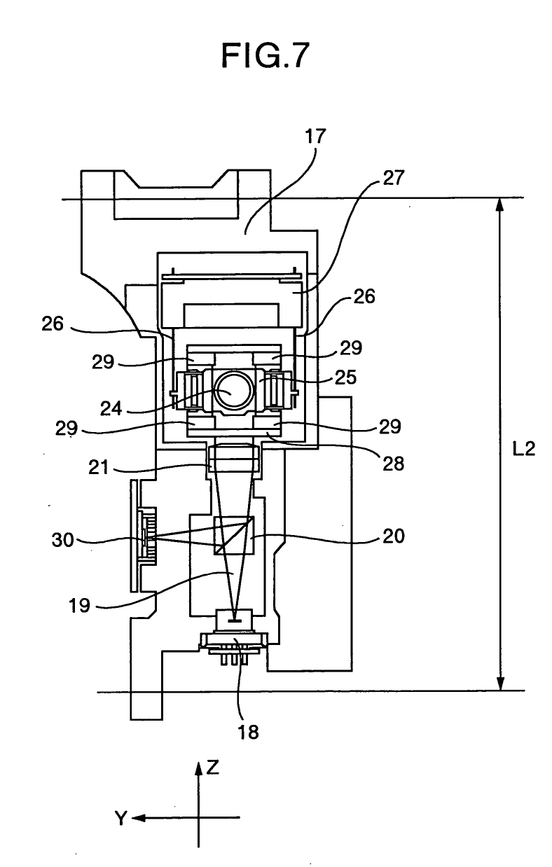

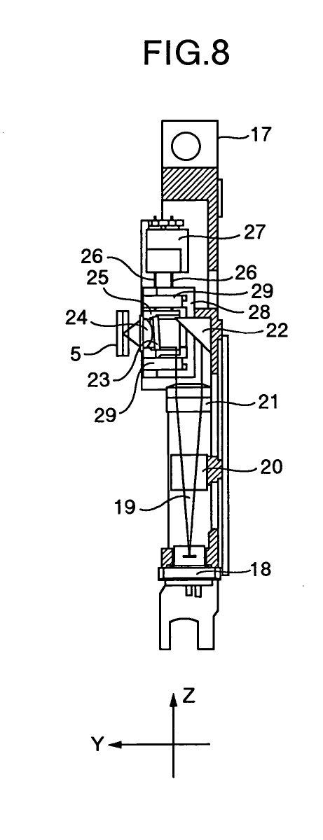

Referring to FIGS. 1 to 4, detailed explanation will be hereinbelow made of an embodiment of the present invention. Like reference numerals will be used to denote components having functions like to those of the conventional video camera which has been explained with reference to FIGS. 5 to 8 so as to omit detailed description thereof.

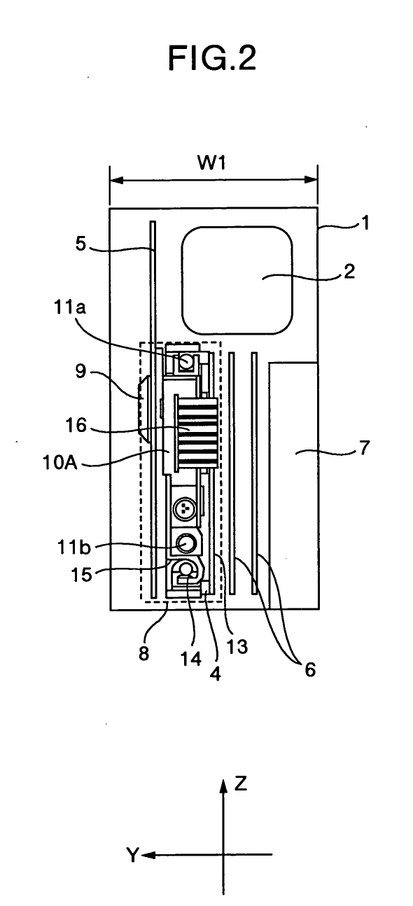

Referring to FIGS. 1 and 2 which are a side view and a front view (viewed in the X-axial direction), respectively, illustrating a video camera using an optical disc in an image pick-up mode, a camera lens 2 and a view finder 3 are arranged in a camera housing 1, being coaxial with each other in the X-axial direction above an optical disc unit 4 (as viewed in the Z-axial direction), and camera circuit boards 6 and a liquid crystal display unit 7 are arranged, being juxtaposed with the optical disc unit 4 in the Y-axial direction.

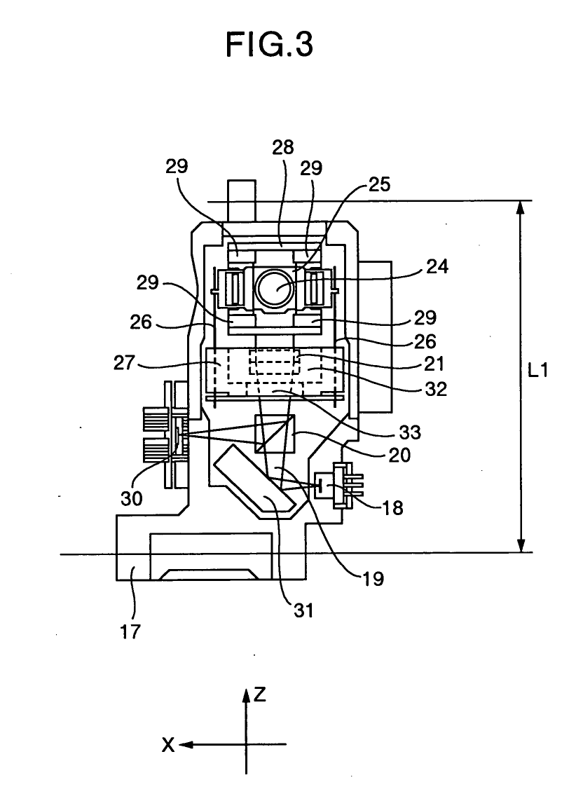

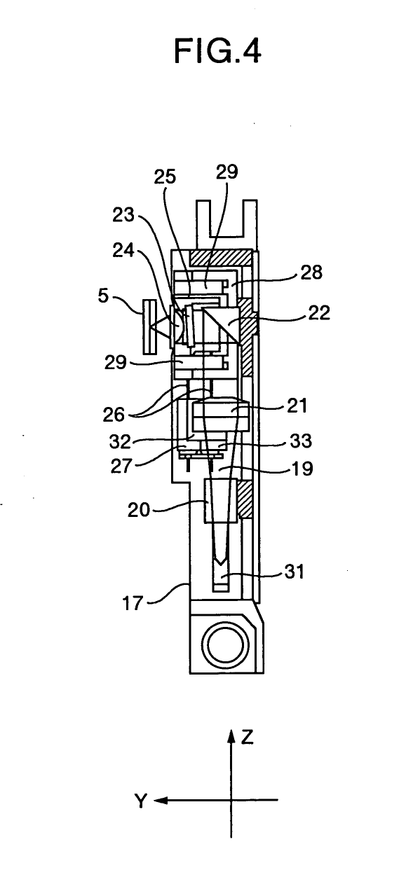

An optical head 10A will be explained with reference to FIGS. 3 and 4. In the optical head 10A, a laser beam 19 emitted from a laser diode 18 attached to a casing 17, is deflected in its advancing direction by a mirror 31 from the X-axial direction into the Z-axial direction, then, passing through a polarized beam splitter 20, and is turned into a parallel ray beam by a collimating lens 21. Then it is reflected into the Y-axial direction by a rise-up mirror 22, passing through a polarization diffraction grating 23, and is focused onto an optical disc 5 by an objective lens 24. A reflected beam from the optical disc 5 passes through the optical path in a reversed order with respect to the incident light beam, and is reflected by the polarized beam splitter 20 onto a photo detector 30. Data on the optical disc 5 is reproduced and a positional deviation signal between the focus point of the laser beam 19 and the recording surface of the optical disc 5 and a positional deviation signal between the focus point and a recording track are detected with the use of an output from the photo detector 30.

The polarization diffraction grating 23 and the objective lens 24 are mounted on a lens holder 25 of an objective lens actuator, and four bar suspensions 26 are secured at one end to the lens holder 25 and at the other end to a holder 27 fixed to the casing 17. The lens holder 25 is attached thereto with a coil which is not shown, which constitutes a voice coil motor in combination of a yoke 28 and a magnet 29.

In the vide camera using an optical disc in this embodiment, the optical disc unit 4 is laid without overlapping with the camera lens 2 and the view finder 3 in a direction perpendicular to the optical disc 5 (Y-axial direction). With this arrangement, the thickness W1 of the camera housing 1 can been reduced to about 40 mm in comparison with the thickness W2 (about 50 mm) of the conventional vide camera shown in FIGS. 5 to 8.

Further, in the vide camera using an optical disc in this embodiment, the optical head 10 is small-sized, and the seek motor 12 is located on one side of the optical head 10A, remote from the camera lens 2. With this configuration, the height of the camera housing 1 in this embodiment can be substantially equal to that of the conventional one shown in FIG. 5. That is, this value does not exceed the diameter (80 mm in this embodiment) of the optical disc by about 10 mm. With this configuration, the optical disc unit 4 can be laid without overlapping with the camera lens 2 and the view finder 3 in the direction perpendicular to the optical disc (Y-axial direction) without changing the height of the video camera using an optical disc. Thus, in addition to the effect of thinning, the effect of miniaturization can also be obtained since it is not required to increase the height hereof, thereby it is possible to enhance easy handling and portability.

The optical head 10A in this embodiment is small-sized so that the space L1 between the two guide bars 11a,11b can be set to about 40 mm which is narrower than that in the optical head 10B shown in FIGS. 5 to 8. That is, a relationship L1<L2 can be given. The object lens 24 has to be displaced between the inner periphery and the outer periphery of the optical disc 5 in the radial direction of the optical disc 5. As shown in FIG. 1, when the optical head 10A is displaced between the inner periphery and the outer periphery of the optical disc 4, the direction of displacement of the optical head 10A is preferably set to be in parallel with the X-axial direction in order to minimize the height (in the Z-axial direction) of the video camera. Accordingly, the objective lens 24 is positioned on a straight line which is passing through the center of the spindle motor 9 and which is in parallel with the X-axial direction.

By decreasing the space L1 between the two guide bars 11a, 11b, the height of the camera housing 1 measured from the center of the optical disc 5 to the end of the video camera housing 1 has not to be changed even though the seek motor 12 is located on one side of the optical head 10A, remote from the camera lens 2 and the view finder 3. Further, by decreasing the space L1 between the two guide bars 11a, 11b, the distance from the objective lens 24 to the upper guide bar 11a can be decreased, and accordingly, the height of the chassis 8 can be decreased to a value substantially equal to that of the upper part of the periphery of the spindle motor 9 since the distance from the objective lens 24 to the upper guide bar 11a can be decreased.

With this configuration, the optical head 10A and the chassis 8 can be juxtaposed with the camera lens 2 in a X-Y plane without the Z-axial dimension of the camera housing 1 being increased, and accordingly, since the camera lens 2 and the optical disc unit 4 are not overlapped with each other in the thicknesswise direction (Y-axial direction), the optical disc 5 can be relatively approached by the camera lens 2. In order to prevent the optical disc 5 from making contact with the camera lens 2 upon loading or unloading of the optical disc 5, the provision of a wall is required between the optical disc 5 and the camera lens 2. In the configuration of this embodiment, the distance between the optical disc 5 and the camera lens 2 can be deceased to about 4 mm in comparison with the video camera shown in FIGS. 5 to 8, in which this distance is about 15 mm.

Similarly, the optical disc 5 can be approached by the view finder 3 which is therefore prevented from being overlapped with the optical disc unit 4 since the seek motor 12 is located on the side of the objective lens, remote from the camera lens, and since the circuit board 13 and the chassis 8 can be miniaturized.

It is noted that the miniaturization of the circuit board can be materialized by enhancing the packaging density of components and by using miniaturized components.

As stated above, since the camera lens 2 and the view finder 3 are not overlapped with the optical disc unit 4. The widths can be greatly decreased to about 11 mm in this part.

Referring to FIGS. 3 and 4, explanation will be hereinbelow made of the configuration of the optical head 10A incorporated in the video camera using an optical disc. FIG. 3 is a plan view illustrating the optical head 10A, and FIG. 4 is a sectional view along the center line thereof in the XY plane.

Although the laser beam emitted from the semiconductor laser 18 is directly incident upon the collimator lens 21 in the optical head 10B shown in FIGS. 5 to 8, the optical path in the optical head 10A in this embodiment is intermediately folded in order to miniaturize the optical head 10A. In this configuration, the semiconductor laser 18 is arranged so that the light beam emitted therefrom is advanced in a direction which is not the Z-axial direction but in the X-axial direction, and a mirror 31 is additionally provided so that the laser beam in the X-axial direction emitted from the semiconductor laser 18 is folded by the mirror 31 from the X-axial direction into a direction toward the collimator lens 21, that is, the Z-axial direction. With this configuration, the distance from the objective lens 24 to the guide bar 11b on the side remote from the camera lens 2 can be decreased from L2 to L1.

Further, the provision of the holder 27 on the optical path of the lease beam 19 is different from the configuration of the optical head 10B. Thus, the distance from the objective lens 24 to the guide bar 11a on the camera lens side can be decreased.

It is noted here that should the holder 27 be arranged on the side of the objective lens remote from the camera lens, it would interfere with the collimator lens 21, and the laser beam 9 is partly blocked. In order to arrange the holder 27 on the side remote from the camera lens without increasing the thickness of the optical head 10A, the holder 27 is additionally formed with a run-off part 32 for the collimator lens 21 and a cutout 33 for passing the lease beam therethrough, thereby it is possible to prevent the holder 27 making contact with the collimator lens 21 and to prevent the holder 27 from blocking the laser beam 19. Since should the thickness of the optical head 10 be increased, the thickness of the vide camera using an optical disc would be increased, the above-mentioned configuration also contribute to the thinning of the video camera using an optical disc.

In the above-mentioned embodiment, although the explanation has been hereinabove made of such a configuration that the optical disc unit is arranged in a plane in parallel with the optical disc without being overlapped with both camera lens 2 and view finder 3, the present invention should not be limited to this configuration, but there may be used such a configuration that the optical disc unit is prevented from being overlapped with at least one of the camera lens 2 and the view finder 3, which has a thickness smaller than that of the other. Even with this configuration, it is possible to aim at thinning the video camera.

In the embodiment stated hereinabove, although explanation has been made of such a configuration that the camera lens 2 and the view finder 3 are located in the upper part of the video camera, the camera lens 2 and the view finder 3 may be arrange in the lower part thereof. In this case, the arrangement of the components is reversed to that of the embodiment stated above. That is, the seek motor 12 is arranged on the upper side of the optical head 10A while the holder 21 is arranged on the upper side of the objective lens 24. With this configuration, technical effects and advantages similar to those obtained by the embodiment stated above can be obtained.

In the embodiment stated above, although explanation has been made of the seek motor 12 used in the displacing mechanism for the optical head 10, the invention should not be limited to this configuration. For example, a motor and a lead screw coupled with each other by a gear may be used, instead of the seek motor. Further, a linear voice coil motor may be used.

In the above-mentioned embodiment, although explanation has been made of the seek motor 12 and the guide bar 11b which are separated from each other, the present invention should not be limited this configuration. For example, the lead screw 14 of the seek motor 12 may be used as the guide bar 11b. That is, instead of the guide bar 11b, the lead screw 12 may be extended through the optical head 10 so as to serve as the guide bar 11b. In this case, even though the distance from the objective lens 24 to the guide bar 11b on the seek motor 12 side is not decreased without using the mirror 31 between the semiconductor laser 18 and the collimator lens, the optical head 10 may be possibly located below the camera lens 2 and the view finder 3 without increasing the height of the camera housing 1.

According to the present invention, it is possible to aim at thinning the video camera using an optical disc.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A video camera using an optical disc, comprising:
an image pick-up optical system including a camera lens for taking up image data to be picked up, and a view finder for displaying the image data; and
an optical disc unit for recording the image data on an optical disc;
wherein the optical disc unit is arranged in a plane which faces the optical disc and which is laid in parallel with the optical disc, without being overlapped with a part of the image pick-up optical system.

2. A video camera using an optical disc as set forth in claim 1, wherein the optical disc unit is not overlapped with the camera lens.

3. A video camera using an optical disc as set forth in any one of claims 2, wherein the video camera has a height which does not exceed a diameter of the optical disc by 10 mm.

4. A video camera using an optical disc as set forth in claim 2, wherein the optical disc unit comprises an optical head for irradiating a light beam on the optical disc, and a drive means for driving the optical head, and the drive means is laid in a plane which faces the optical disc and which is laid in parallel with the optical disc, on one side of the optical head, remote from the camera lens.

5. A video camera using an optical disc as set forth in claim 2, wherein the optical disc unit comprises an optical head for irradiating a light beam onto the optical disc through the intermediary of an objective lens, which includes a lens holder for holding the objective lens, a support member having a first end and a second end, for folding, at one end thereof, the lens holder, and a holder for holding the second end of the support member, and the holder is located in a plane which faces the optical disc and which is laid in parallel with the optical disc, on one side of the objective lens, remote from the camera lens.

6. A video camera using an optical disc as set forth in claim 5, wherein the optical head includes a laser source for emitting a laser beam, and the laser source is located so that the laser beam emitted therefrom becomes parallel with the support member for holding the optical head.

7. A video camera using an optical disc as set forth in claim 5, wherein the optical head includes a laser source for emitting a laser beam, a mirror for reflecting the laser beam and a collimator lens for turning the laser beam into a parallel ray beam, and the mirror is located on a optical path between the laser source and the collimator lens.

8. A video camera using an optical disc as set forth in claim 1, wherein the optical disc unit is not overlapped with the view finder.

9. A video camera using an optical disc as set forth claim 8, wherein the video camera has a height which does not exceed a diameter of the optical disc by 10 mm.

10. A video camera using an optical disc as set forth claim 9, wherein the optical disc unit comprises an optical head for irradiating a light beam on the optical disc, and a drive means for driving the optical head,
and the drive means is laid in a plane which faces the optical disc and which is laid in parallel with the optical disc, on one side of the optical head, remote from the view finder.

11. A video camera using an optical disc as set forth claim 9, wherein the optical disc unit comprises an optical head for irradiating a light beam onto the optical disc through the intermediary of an objective lens, which includes a lens holder for holding the objective lens, a support member having a first end and a second end, for folding, at one end thereof, the lens holder, and a holder for holding the second end of the support member, and the holder is located in a plane which faces the optical disc and which is laid in parallel with the optical disc, on one side of the objective lens, remote from the camera lens.

12. A video camera using an optical disc as set forth in claim 9, wherein the optical head includes a laser source for emitting a laser beam, and the laser source is located so that the laser beam emitted therefrom becomes parallel with the support member for holding the optical head.

13. A video camera using an optical disc as set forth in claim 9, wherein the optical head includes a laser source for emitting a laser beam, a mirror for reflecting the laser beam and a collimator lens for turning the laser beam into a parallel ray beam, and the mirror is located on a optical path between the laser source and the collimator lens.

14. A video camera using an optical disc as set forth in claim 1, wherein the optical disc unit is not overlapped with both camera lens and view finder.

15. A video camera using an optical disc as set forth in claim 14, wherein the video camera has a height which does not exceed a diameter of the optical disc by 10 mm.

16. A video camera using an optical disc as set forth in claim 14, wherein the optical disc unit comprises an optical head for irradiating a light beam on the optical disc, and a drive means for driving the optical head, and the drive means is laid in a plane which faces the optical disc and which is laid in parallel with the optical disc, on one side of the optical head, remote from the camera lens.

17. A video camera using an optical disc as set forth in claim 14, wherein the optical disc unit comprises an optical head for irradiating a light beam on the optical disc, and a drive means for driving the optical head,
and the drive means is laid in a plane which faces the optical disc and which is laid in parallel with the optical disc, on one side of the optical head, remote from the view finder.

18. A video camera using an optical disc as set forth in claim 14, wherein the optical disc unit comprises an optical head for irradiating a light beam onto the optical disc through the intermediary of an objective lens, which includes a lens holder for holding the objective lens, a support member having a first end and a second end, for folding, at one end thereof, the lens holder, and a holder for holding the second end of the support member, and the holder is located in a plane which faces the optical disc and which is laid in parallel with the optical disc, on one side of the objective lens, remote from the camera lens.

19. A video camera using an optical disc as set forth in claim 14, wherein the optical disc unit comprises an optical head for irradiating a light beam onto the optical disc through the intermediary of an objective lens, which includes a lens holder for holding the objective lens, a support member having a first end and a second end, for folding, at one end thereof, the lens holder, and a holder for holding the second end of the support member, and the holder is located in a plane which faces the optical disc and which is laid in parallel with the optical disc, on one side of the objective lens, remote from the camera lens.

20. A video camera using an optical disc as set forth in claim 1, wherein the video camera has a height which does not exceed a diameter of the optical disc by 10 mm.

21. A video camera using an optical disc as set forth in claim 20, wherein the optical disc unit comprises an optical head for irradiating a light beam on the optical disc, and a drive means for driving the optical head, and the drive means is laid in a plane which faces the optical disc and which is laid in parallel with the optical disc, on one side of the optical head, remote from the camera lens.

22. A video camera using an optical disc as set forth in claim 20, wherein the optical disc unit comprises an optical head for irradiating a light beam on the optical disc, and a drive means for driving the optical head,
and the drive means is laid in a plane which faces the optical disc and which is laid in parallel with the optical disc, on one side of the optical head, remote from the view finder.

23. A video camera using an optical disc as set forth in claim 20, wherein the optical disc unit comprises an optical head for irradiating a light beam onto the optical disc through the intermediary of an objective lens, which includes a lens holder for holding the objective lens, a support member having a first end and a second end, for folding, at one end thereof, the lens holder, and a holder for holding the second end of the support member, and the holder is located in a plane which faces the optical disc and which is laid in parallel with the optical disc, on one side of the objective lens, remote from the camera lens.

24. A video camera using an optical disc as set forth in claim 20, wherein the optical disc unit comprises an optical head for irradiating a light beam onto the optical disc through the intermediary of an objective lens, which includes a lens holder for holding the objective lens, a support member having a first end and a second end, for folding, at one end thereof, the lens holder, and a holder for holding the second end of the support member, and the holder is located in a plane which faces the optical disc and which is laid in parallel with the optical disc, on one side of the objective lens, remote from the camera lens.
